(19) United States
(12) Patent Application Publication
(10) Pub. No.: US 2026/0111764 A1
(43) Pub. Date: Apr. 23, 2026

(54) KNOW-HOW MANAGEMENT METHOD AND INFORMATION PROCESSING APPARATUS

(71) Applicant: TOYOTA JIDOSHA KABUSHIKI KAISHA, Toyota-shi (JP)

(72) Inventors: Manabu OKUYAMA, Nisshin-shi (JP); Masayuki OKAMOTO, Nagoya-shi (JP); Naoki YAMAMURO, Nagoya-shi (JP); Yasuomi TAKEUCHI, Toyota-shi (JP)

(73) Assignee: TOYOTA JIDOSHA KABUSHIKI KAISHA, Toyota-shi (JP)

(21) Appl. No.: 19/361,317

(22) Filed: Oct. 17, 2025

(30) Foreign Application Priority Data
Oct. 23, 2024 (JP) 2024-186976

(51) Int. Cl. G06N 5/022

(52) U.S. Cl. CPC G06N 5/022

(57) ABSTRACT

A know-how management method performed by an information processing apparatus includes identifying, upon acquiring know-how information, a technical field of the know-how information, and performing version management of a plurality of pieces of know-how information independently for each identified technical field.

### CROSS-REFERENCE TO RELATED APPLICATION

This application claims priority to Japanese Patent Application No. 2024-186976 filed on Oct. 23, 2024, the entire contents of which are incorporated herein by reference.

### TECHNICAL FIELD

The present disclosure relates to a know-how management method and an information processing apparatus.

### BACKGROUND

Patent Literature (PTL) 1 discloses technology for generating, based on a given technical field, a dialogue bot specialized for the technical field using a large language model.

### CITATION LIST

### Patent Literature

PTL 1: JP 2023-076413 A

### SUMMARY

In a dialogue system, one or more pieces of know-how information that could be an answer to an input question may be retrieved from a database and displayed. However, the method of time-series management of know-how information is not adequately considered in PTL 1.

It would be helpful to facilitate time-series management of know-how by using machine learning or the like and increase the reliability of accumulated know-how.

A know-how management method according to an embodiment of the present disclosure includes:
identifying, upon acquiring know-how information, a technical field of the know-how information; and
performing version management of a plurality of pieces of know-how information independently for each identified technical field.

According to the present disclosure, it is possible to facilitate time-series management of know-how by using machine learning or the like and increase the reliability of accumulated know-how.

### BRIEF DESCRIPTION OF THE DRAWINGS

In the accompanying drawings:

FIG. 1 is a block diagram illustrating a configuration of an information processing apparatus according to an embodiment of the present disclosure; and

FIG. 2 is a flowchart illustrating example operations of the information processing apparatus according to an embodiment of the present disclosure.

### DETAILED DESCRIPTION

An embodiment of the present disclosure will be described below, with reference to the drawings. In the drawings, portions having the same configuration or function are denoted by the same reference numerals. In the description of the present embodiment, duplicate descriptions of the same portions are in some cases omitted or simplified, as appropriate.

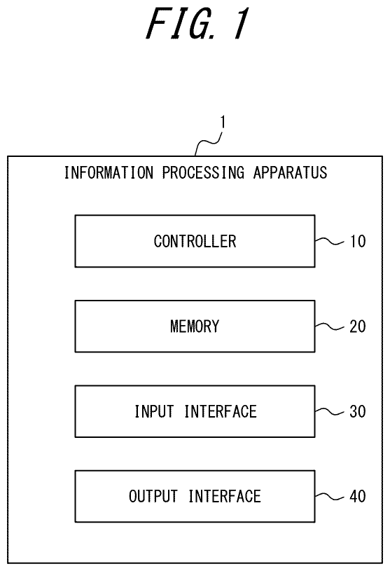

A configuration of an information processing apparatus 1 according to an embodiment of the present disclosure will be described with reference to FIG. 1.

The information processing apparatus 1 includes a controller 10, a memory 20, an input interface 30, and an output interface 40.

The controller 10 includes one or more processors, one or more dedicated circuits, or a combination of these to perform the predetermined processing. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 10 executes various processes related to the operations of the information processing apparatus 1 and controls various parts of information processing apparatus 1.

The memory 20 includes at least one semiconductor memory, at least one magnetic memory, at least one optical memory, or a combination of at least two of these. The memory 20 stores data to be used for the operations of the information processing apparatus 1 and data obtained by the operations of the information processing apparatus 1.

The input interface 30 includes at least one interface for input. The interface for input is, for example, a physical key, a capacitive key, a pointing device, a touch screen integrally provided with a display, or a microphone that receives audio input. The input interface 30 accepts an operation for inputting information to be used for the operations of the information processing apparatus 1.

The output interface 40 includes at least one interface for output. The interface for output is, for example, a connection interface to an external or built-in display or external output device that outputs information as images and video. The display is, for example, a liquid crystal display (LCD) or an organic electro luminescent (EL) display. The output interface 40 outputs information obtained by the operations of the information processing apparatus 1.

The following is a description of a know-how management method in accordance with one embodiment of the present disclosure.

Upon acquiring new know-how information via the input interface 30, the controller 10 identifies the technical field to which the know-how information belongs. The technical fields may be stored in the memory 20 in advance. The technical field may be, for example, “safety technology”, “how to prescribe employee regulations”, etc. When acquiring new know-how information, the controller 10 may also acquire information on the technical field to which the know-how information belongs, or may identify the technical field to which the know-how information belongs from the title or content of the know-how information. The technical field may be identified based on a trained model generated by machine learning using data linking, for example, the title or content of the know-how information with the technical field to which it belongs as teacher data.

The controller 10 performs version management of know-how information for each technical field. The controller 10 may perform version management of one or more pieces of specific know-how information with the first technical field and other technical fields as the second technical field. In other words, all know-how belonging to technical fields other than the technical field of specific know-how information may be grouped together for version management.

Upon newly acquiring know-how information for a specific technical field, the controller 10 may determine whether the newly acquired know-how information is valid. For example, a skill map of the know-how information provider may be used as a criterion for the above decision. Validity may be determined by whether the skill map of the know-how information provider is equal to or more than a predetermined threshold. The skill map shall include, but not be limited to, length of service, position, etc. The controller 10 may determine that the know-how information is reasonable if, for example, for a specific technical field, the length of service of the know-how information provider is equal to or more than a predetermined threshold. On the other hand, if the length of service of the know-how information provider is less than a predetermined threshold, one or more predetermined number of experts may be requested to determine the validity of the know-how information. Experts may, for example, be persons whose length of service is equal to or more than a predetermined threshold.

Upon determining that the know-how information is valid, the controller 10 stores the know-how information as the latest version of information. On the other hand, upon determining that the know-how information is not valid, the controller 10 may not store the know-how information, or may store the know-how information as low reliability information.

Upon acquiring a question regarding the technical field of the accumulated know-how information, the controller 10 calculates the similarity with the stored know-how information. Then, based on the know-how information with a high degree of similarity, an answer to the question may be generated and output to the output interface 40. For example, when a question about a failure case is input, the controller 10 may generate an answer based on know-how information (e.g., failure cases) that is highly similar to the failure case and predict the failure that will occur. Response generation may be performed using a large language model (LLM) learned from accumulated know-how information or a retrieval augmented generation (RAG) using accumulated know-how information as a database.

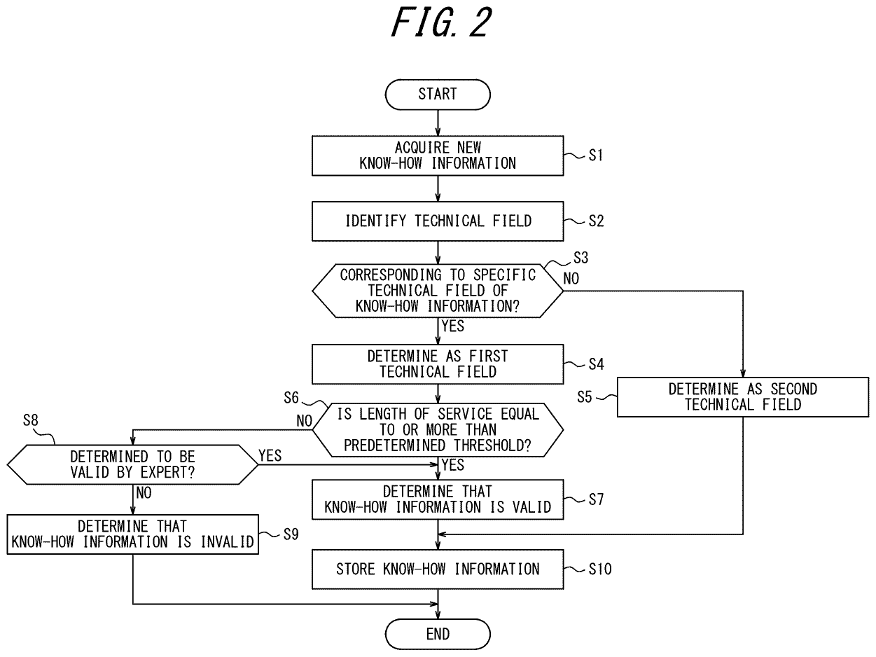

The following describes a know-how management method using information processing apparatus 1 in accordance with one embodiment of the present disclosure with reference to FIG. 2.

In step S1, the controller 10 acquires new know-how information via the input interface 30. When accepting input of know-how information, the controller 10 may display the technical fields stored in the memory 20 on the output interface 40 and accept input for selecting the technical field to which the know-how information belongs.

In step S2, the controller 10 identifies the technical field to which the new know-how information acquired in step S1 belongs. There is no particular limit to the identification method. For example, the controller 10 may perform machine learning using data linking the title or content of the know-how information and the technical field to which it belongs as teacher data, and identify the technical field to which the new know-how information belongs based on the generated trained model.

If the input of the technical field to which the new know-how information belongs is accepted in step S1, the inputted technical field may be identified as the technical field to which the new know-how information belongs.

In step S3, the controller 10 determines whether the know-how information acquired in step S1 corresponds to a predetermined specific technical field of know-how information. If the know-how information corresponds to the specific technical field of know-how information (step S3: Yes), the controller 10 determines the know-how information to be information that belongs to the first technical field (step S4) and proceeds to step S6.

If the know-how information does not correspond to the specific technical filed of know-how information (step S3: No), the controller 10 determines the know-how information to be information that belongs to the second technical field (step S5) and proceeds to step S10.

In step S6, the controller 10 determines the validity of the know-how information that was determined to belong to the first technical field in step S3. Specifically, the controller 10 determines the validity of the know-how information based on the length of service of the know-how information provider. If the length of service of the know-how information provider is equal to or more than the predetermined threshold (step S6: Yes), the controller 10 determines that the know-how information is valid (step S7) and proceeds to step S10. If the length of service of the know-how information provider is less than the predetermined threshold (step S6: No), the controller 10 requests one or more predetermined number of experts to determine the validity of the know-how information.

In step S8, the controller 10 accepts input of the determination result on the validity of the know-how information from the expert. If a determination input is accepted from an expert that the know-how information is valid (step S8: Yes), the controller 10 determines that the know-how information is valid (step S7) and proceeds to step S10. If a determination input is accepted from an expert that the know-how information is invalid (step S8: No), the controller 10 determines that the know-how information is invalid (step S9) and terminates the process without storing the know-how information.

In step S10, the controller 10 stores the know-how information as the latest version of information in the technical field to which the know-how information belongs and terminates the process.

By using the above method, it is possible to perform version management of know-how information for each technical field and facilitate time-series management of know-how. In technical fields that require careful updating of know-how information, such as information on safety measures, only highly reliable know-how information can be updated.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

1. A know-how management method performed by an information processing apparatus, the know-how management method comprising:
identifying, upon acquiring know-how information, a technical field of the know-how information; and
performing version management of a plurality of pieces of know-how information independently for each identified technical field.

2. The know-how management method according to claim 1, wherein the identifying of the technical field identifies the technical field of the know-how information based on a trained model generated by machine learning.

3. The know-how management method according to claim 1, further comprising:
determining, upon newly acquiring know-how information for a specific technical field, whether the newly acquired know-how information is valid; and
storing the newly acquired know-how information as a latest version of information in a case in which the newly acquired know-how information is determined to be valid, and not storing the newly acquired know-how information in a case in which the newly acquired know-how information is determined to be invalid.

4. The know-how management method according to claim 3, wherein
the determining of whether the newly acquired know-how information is valid is performed based on a skill map of a know-how information provider, and
the skill map includes information on length of service of the know-how information provider.

5. An information processing apparatus comprising a controller configured to:
identify, upon acquiring know-how information, a technical field of the know-how information; and
perform version management of a plurality of pieces of know-how information independently for each identified technical field.
